(19) United States
(12) Patent Application Publication
(10) Pub. No.: US 2005/0279763 A1
(43) Pub. Date: Dec. 22, 2005

(54) Dispensing station

(76) Inventors: Loren S. Adell, Collin County, TX (US); Michael L. Adell, Dallas County, TX (US)

Correspondence Address: W. THOMAS TIMMONS;THE WHITE HOUSE ON TURTLE CREEK, 2401 TURTLE CREEK BLVD, DALLAS, TX, 75219-4760, US

(21) Appl. No.: 11/057,293

(22) Filed: Feb. 11, 2005

Related U.S. Application Data
(63) Continuation-in-part of application No. 60/544,292, filed on Feb. 12, 2004.

(51) Int. Cl. B67D 5/52

(52) U.S. Cl. 222/137; 222/179; 222/145.5

(57) ABSTRACT

A dispensing station according to the present invention includes a pneumatic or hydraulic cylinder, the plunger of which forces prepackaged materials from two tubes or a dual tube housing through a dispensing tube. The dual housing keeps the A and B materials separate until they are forced out by pneumatic cylinder. A knob adjusts the air pressure to pneumatic cylinder in response to a foot pedal. Alternatively, time and pressure can programmed into a device for metering materials. The device for metering materials can be set to adjust the pressure from pneumatic cylinder by outlet tubes and meters dispensing of the combined A and B materials through other tubes. The combined materials are dispensed onto a work product, such as a dental model which rests on a base support, for producing a dental device. A pole is vertically mounted on the base support. The combined unit comprising pneumatic or hydraulic cylinder, two tubes or a dual tube housing and associated structure is adjustably mounted on the pole. An angle adjustment knob allows a user to adjust the angle of the unit. Loosening another knob allows the units to be raised or lowered. A dispensing tip is an adjustable cut-off device such as a pinch valve. A spring adjuster acts as a counter balance to ease manipulation of the dispensing tube. One arrangement of the dispensing tube includes a gun and a static mixer.

### CROSS-REFERENCE TO RELATED APPLICATIONS

Provisional Patent Application Ser. No. 60/544,292

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to devices for dispensing materials which can be dispensed through tubes.

2. Description of Related Art

Dental laboratories dispense materials such as impression materials using a manual gun or an electric gun. Such dispensing guns are good for prototype use or even small batch runs but are not well suited for high volume production.

Dispensing stations have been known in the automobile industry, but the dispensing portion must still be handled manually, requiring considerable strength and stamina.

### BRIEF SUMMARY OF THE INVENTION

A dispensing station according to the present invention includes a pneumatic cylinder, the plunger of which forces prepackaged materials from a dual tube housing through a dispensing tube. The dual housing keeps the A and B materials, such as a base and a catalyst, separate until they are forced out by pneumatic cylinder. A knob adjusts the air pressure to pneumatic cylinder in response to a foot pedal. Alternatively, time and pressure can programmed into a device for metering materials. The device for metering materials can be set to adjust the pressure from pneumatic cylinder by outlet tubes and meters dispensing of the combined A and B materials through other tubes. The combined materials are dispensed onto a work product, such as a dental model which rests on a base support, for producing a dental device.

A pole is vertically mounted on the base support. The combined unit comprising pneumatic cylinder, dual tube housing and associated structure is adjustably mounted on the pole. An angle adjustment knob allows a user to adjust the angle of the unit. Loosening another knob allows the units to be raised or lowered.

A dispensing tip is an adjustable cut-off device such as a pinch valve.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a top front right perspective view of a dispensing station according to the present invention;

FIG. 2 is an alternative embodiment of a dispensing station according to the present invention;

### DETAILED DESCRIPTION OF THE INVENTION

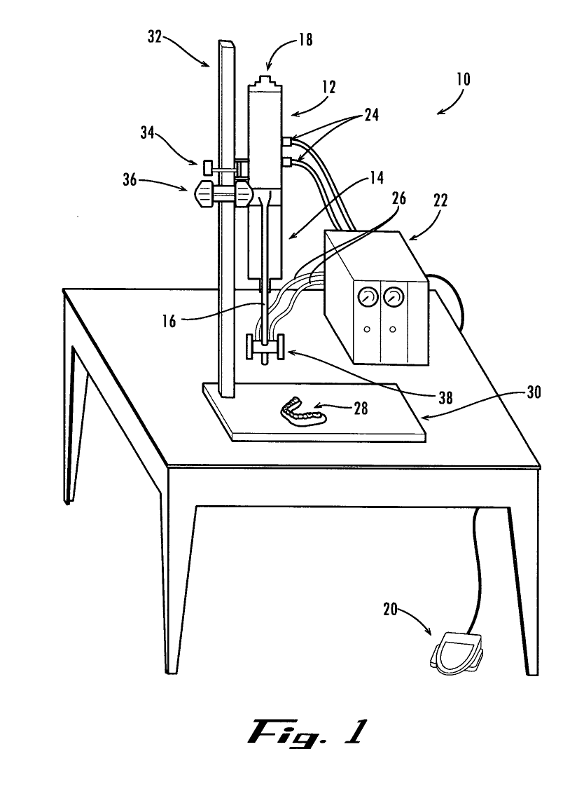

Referring now to the drawing, and in particular to FIG. 1, a dispensing station according to the present invention is referred to generally by reference numeral 10. Dispensing station 10 includes a pneumatic cylinder 12, the plunger of which forces prepackaged materials from at least two reservoirs, such as dual tube housing 14 through a dispensing tube 16. Dual housing 14 keeps the A and B materials separate until they are forced out by pneumatic cylinder 12. A knob 18 adjusts the air pressure to pneumatic cylinder 12 in response to foot pedal 20. Alternatively, time and pressure can programmed into device 22 for metering materials. Device 22 can be set to adjust the pressure from pneumatic cylinder 12 by outlet tubes 24 and meters dispensing of the combined A and B materials through tubes 26. The combined materials are dispensed onto a work product, such as a dental model 28 which rests on a base support 30, for creating a dental device.

A pole 32 is vertically mounted on base support 30. The combined unit comprising pneumatic cylinder 12, dual tube housing 14 and associated structure is adjustably mounted on pole 32. An angle adjustment knob 34 allows a user to adjust the angle of the unit and loosening another knob 36 allows the units to be raised or lowered.

A dispensing tip 38 is an adjustable cut-off device such as a pinch valve.

Dispensing station 10 is able to dispense A and B materials in any ratio, such as 1:1, 2:1, 4:1, 10:1 etc. Metering device 22 would be used is an exact amount of material needs to be dispensed at a time. For high volume, dispensing station 12 can dispense A and B materials directly out of larger reservoirs, such as containers of 5 gallons or larger. A larger pneumatic cylinder can be used for such cases.

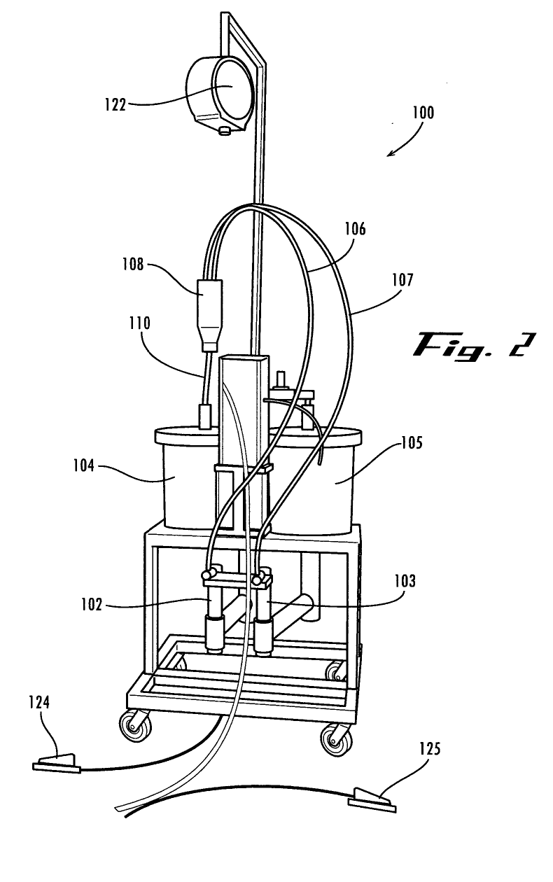

Referring now to FIG. 2, an alternative embodiment of a dispensing station according to the present invention is referred to generally by reference numeral 100. Dispensing station 100 includes pneumatic or hydraulic cylinders 102 and 103, the plungers of which force prepackaged materials from at least two reservoirs 104 and 105 through tubes 106 and 107 to a dispensing tube comprising a gun 108 and a static mixer 110. Cylinders 102 and 103 are part of two metering pumps. The air pressure to pneumatic cylinders 102 and 103 can be adjusted in response to foot pedals 120 and 121. Alternatively, time and pressure can programmed into the device for metering materials. A spring adjuster 122 is mounted above tubes 106 and 107 and above gun 108 and static mixer 110. Spring adjuster 122 is attached to the dispensing tube through tubes 106 and 107, although it could connect to the dispensing tube directly, to act as a counter balance. This greatly eases moving gun 108 and static mixer 110. Two foot pedals 124 and 125 allow two work stations. As one worker is processing the previous batch, the second worker can dispense the next batch of material. The counter balanced dispensing tube is easily moved from one worker to the next. The combined materials are dispensed onto a work product, such as a dental model, or other method of making a dental device.

One advantage of a dispensing station according to the present invention is that a lab technician can use both hands when working on a dental device, using his or her feet to control dispensing rate.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A dispensing station comprising, in combination:
at least two reservoirs for holding at least two materials;
a dispensing tube;
at least one cylinder for pumping the materials from the at least two reservoirs through the dispensing tube;
at least one foot pedal for metering the materials, wherein the cylinder is responsive to the foot pedal.

2. A dispensing station according to claim 1, wherein the dispensing tube comprises a static mixer.

3. A dispensing station according to claim 1, further comprising an adjustable cut-off dispensing device attached to the output end of the dispensing tube.

4. A dispensing station according to claim 1, further comprising:
at least one tube connecting the reservoir through the at least one cylinder to the dispensing tube for the flow of the materials to the dispensing tube; and
a spring adjuster attached to the dispensing tube to act as counter balance to the dispensing tube and materials.

5. A dispensing station according to claim 4, wherein the dispensing tube comprises a static mixer.

6. A dispensing station according to claim 4, further comprising an adjustable cut-off dispensing device attached to the output end of the dispensing tube.

7. A dispensing station comprising, in combination:
at least two reservoirs for holding at least two materials;
a dispensing tube;
at least one cylinder for pumping the materials from the at least two reservoirs through the dispensing tube;
at least one tube connecting the reservoir through the at least one cylinder to the dispensing tube for the flow of the materials to the dispensing tube; and
a spring adjuster attached to the dispensing tube to act as counter balance to the dispensing tube and materials.

8. A dispensing station according to claim 7, wherein the dispensing tube comprises a static mixer.

9. A dispensing station according to claim 7, further comprising an adjustable cut-off dispensing device attached to the output end of the dispensing tube.

10. A method for producing dental devices, comprising the steps of:
providing at least two materials;
pumping the at least two materials;
combining the at least two materials;
dispensing the combined materials for producing a dental device; and
metering the materials by a foot pedal, wherein the pumping is responsive to the foot pedal.

11. A method for producing dental devices according to claim 10, wherein the step of dispensing the combined materials comprises forcing the materials through a static mixer.

12. A method for producing dental devices according to claim 10, further comprising the step of adjustably cutting off the step of dispensing the combined materials.

13. A method for producing dental devices according to claim 10, further comprising the step of counter balancing the materials and any movable equipment.

14. A method for producing dental devices according to claim 13, wherein the step of dispensing the combined materials comprises forcing the materials through a static mixer.

15. A method for producing dental devices according to claim 13, further comprising the step of adjustably cutting off the step of dispensing the combined materials.

16. A method for producing dental devices, comprising the steps of:
providing at least two materials;
pumping the at least two materials;
combining the at least two materials;
dispensing the combined materials for producing a dental device; and
counter balancing the materials and any movable equipment.

17. A method for producing dental devices according to claim 16, wherein the step of dispensing the combined materials comprises forcing the materials through a static mixer.

18. A method for producing dental devices according to claim 16, further comprising the step of adjustably cutting off the step of dispensing the combined materials.
